(19) United States
(12) Patent Application Publication
(10) Pub. No.: US 2010/0121801 A1
(43) Pub. Date: May 13, 2010

(54) ENHANCED MATCHING THROUGH EXPLORE/EXPLOIT SCHEMES

(76) Inventors: H. Scott Roy, Palo Alto, CA (US); Raghunath Ramakirshnan, Madison, WI (US); Pardheep Elgano, Mountain View, CA (US); Nitin Motgi, Santa Clara, CA (US); Deepak K. Agarwal, Sunnyvale, CA (US); Wei Chu, Sunnyvale, CA (US); Bee-Chung Chen, Mountain View (TW)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/267,538

(22) Filed: Nov. 7, 2008

(51) Int. Cl. G06N 5/02; G06F 17/00; G06N 7/00

(52) U.S. Cl. 706/46; 715/234; 706/59

(57) ABSTRACT

Content items are selected to be displayed on a portal page in such a way as to maximize a performance metric such as click-through rate. Problems relating to content selection are addressed, such as changing content pool, variable performance metric, and delay in receiving feedback on an item once the item has been displayed to a user. An adaptation of priority-based schemes for the multi-armed bandit problem are used to project future trends of data. The adaptation introduces experiments concerning a future time period into the calculation, which increases the set of data on which to solve the multi-armed bandit problem. Also, a Bayesian explore/exploit method is formulated as an optimization problem that addresses all of the issues of content item selection for a portal page. This optimization problem is modified by Lagrange relaxation and normal approximation, which allow computation of the optimization problem in real time.

### CROSS REFERENCE TO RELATED APPLICATIONS

This application is related to U.S. patent application Ser. No. ______ (attorney docket no. 50269-1123), titled “ENHANCED MATCHING THROUGH EXPLORE/EXPLOIT SCHEMES,” and filed on the same date herewith.

### FIELD OF THE INVENTION

The present invention relates to Internet portal web pages, and, more specifically, to techniques for employing targeted experiments to select content items to be displayed on an Internet portal web page.

### BACKGROUND

Owners of portal web pages wish to make their pages appealing to potential visitors. One way of making a portal page more enticing to those potential visitors is by placing interesting information on that portal page. For example, one might try to entice users to access a portal page by including, on the portal page, interesting and current content items such as news stories, advertisements, pertinent search results, or media. Such content items may be presented in conjunction with one another, or separately. Furthermore, there may be a substantive representation of the content item directly on the portal page, or the portal page may contain only a link with minimal information about the item.

If visitors to the portal page learn, by experience, that the content shown on the portal page is likely to be of interest to those visitors, and that the content shown on the portal page is likely to be dynamic, updated, fresh, and current each time that those visitors access the portal page, then those visitors will likely want to access that page additional times in the future, and with greater frequency. Also, the dynamic nature of the portal page will enhance the experience of the visitors.

Alternatively, if visitors to the portal page discover, by experience, that the content shown on the portal page is likely to be the same static content that those visitors saw the last time that they visited the portal page, or if visitors to the portal page come to understand that the type of content that is shown on the portal page is a type of content in which they are not interested, then those visitors become more likely, in the future, to forego visiting the portal page and visit other pages instead.

One challenge to the owner or the maintainer of the portal page becomes how to choose, from among the multitude of content that could be presented on the portal page, content that is likely to increase visitor interest in the page. One approach for selecting content might involve hiring a staff of full-time human editors to look for (and/or compile or otherwise produce) news stories and other content items that those editors believe will be interesting to those who visit the portal page. However, such editors are only human, and, as humans, are inherently biased towards their own tastes and preferences. The content that appeals to the editors might not be content that appeals to significant segments of the public. Additionally, a staff of qualified full-time editors can require a significant and recurring monetary investment on the part of the owners of the Internet portal page to maintain or to scale.

Another approach for selecting content for presentation on the portal page is through an automated system. These automated systems are easier to scale and maintain than the staff of editors. The systems generally base content selection on historical information gathered from users of the portal page. For example, automated systems can rely on past user behavior including search queries that were previously entered, advertisements that visitors have clicked on, or information that visitors explicitly give to the portal page. However, such historical data does not always accurately reflect the current trends and desires of the visitors to the portal page. Also, because content for web pages can change very rapidly, the historical data may not include information about the content currently available to display.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an example of a system in which embodiments of the invention may be implemented and practiced;

FIGS. 2A-2D are diagrams that illustrate an example of a set of standard normal distribution graphs approximating probability distributions

FIG. 3 is a flowchart that illustrates an example process of simulating user behavior pertaining to a specified future time period, according to an embodiment of the invention;

FIGS. 4A-4C are diagrams that illustrate a comparison of a set of two standard normal distribution graphs approximating probability distributions; and

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Visitor interest in a portal page-measured by performance metrics such as overall visitor experience, number of page views, and click-through rate—dictates the amount of advertising revenue that will be generated by the portal page. For simplicity, the following discussion will focus on click-through rate as the pertinent performance metric, but a person of skill in the art will appreciate that any yield function could be used as the performance metric. Click-through rate is also known as CTR, and is defined in one embodiment of the invention as a number of clicks on a particular content item divided by a number of times the particular content item has been displayed to users of the portal page.

In one embodiment of the invention, an automated system is used to select and present to users those items in the content pool that will most likely have a high CTR. In another embodiment of the invention, the automated system bases selection of content items for presentation on both historical data and hypothetical data produced by experiments. As previously stated, historical data alone does not reflect changing CTR, and the historical data does not contain information about newly available items. Also, historical data is generally sparse because the number of clicks observed for the items in the content pool is generally low compared to the number of times the items have been presented. Thus, decisions made by the system based on solely historical data cannot account for items of content that would perform very well, but that do not conform to the historical trends.

Thus, experiments based on observed user behavior are employed to investigate changing CTR, the effects of a dynamic content pool, and to find those outlier content items that perform unexpectedly well. These experiments are targeted in such a way as to minimize potential hazards of running experiments on live users, such as lowering user experience and depressing CTR. Through the use of targeted experiments, more information is gathered than would be available by using the historical data alone, and thus items with high CTR will be found more quickly.

Other features that may be included in various different embodiments of the invention are discussed in more detail below.

### Example System

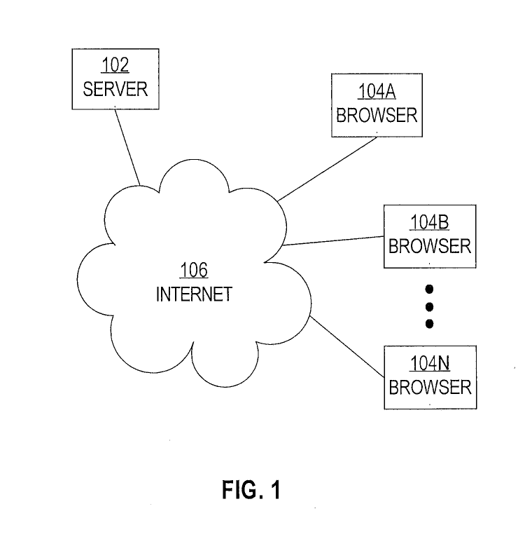

FIG. 1 is a block diagram that illustrates an example of a system in which embodiments of the invention may be implemented and practiced. The system of FIG. 1 comprises a server 102, browsers 104A-N, and Internet 106. Alternative embodiments of the invention may include more, fewer, or different components than those illustrated in FIG. 1.

In one embodiment of the invention, browsers 104A-N execute on separate computers, such as desktop or laptop computers. However, in one embodiment of the invention, one or more of browsers 104A-N executes on a mobile device such as a mobile or cellular telephone.

Each of browsers 104A-N communicates with server 102 via Internet 106. For example, browsers 104A-N may send Hypertext Transfer Protocol (HTTP) requests to, and receive HTTP responses from, server 102 across Internet 106. These HTTP requests and responses may be transmitted according to a multi-level suite of network communication protocols, typically including Transfer Control Protocol (TCP) and Internet Protocol (IP). Each of browsers 104A-N may be used by a different user. Browsers 104A-N may be widely distributed over the entire Earth. Using browsers 104A-N, users of browsers 104A-N specify the URL that is associated with a web page (e.g., the portal web page discussed above) that server 102 stores or dynamically generates. In response to these users specifying the URL, browsers 104A-N request, over Internet 106, from server 102, the web page that is associated with that URL. Server 102 receives these requests and dynamically generates and sends the requested web page to browsers 104A-N over Internet 106 in response.

In one embodiment of the invention, users of browsers 104A-N use browsers 104A-N to access a portal web page that is served by server 102. In one embodiment of the invention, server 102 is, or comprises, a web server. In one embodiment of the invention, the functionality of server 102 is provided instead by multiple separate servers to which the requests of browsers 104A-N are distributed by a load-balancing device that receives those requests. In response to requests from browsers 104A-N for the portal web page, server 102 sends the portal web page over Internet 106 to browsers 104A-N. As discussed above, the portal web page typically contains one or more content items that were selected from a pool of available content items. In response to receiving the portal web page from server 102, browsers 104A-N display the portal web page.

In one embodiment of the invention, server 102 dynamically generates at least portions of the portal web page in response to each request from browsers 104A-N. In one embodiment of the invention, the version of the portal web page that server 102 sends to various ones of browsers 104A-N differs from the version that server 102 sends to other ones of browsers 104A-N. For example, the version of the portal web page sent to browser 104A might contain different selected content items than the version of the portal web page sent to browser 104B.

### The Multi-Armed Bandit Problem

In one embodiment of the invention, a Bayesian explore/exploit solution is used as the content selection algorithm for the automated system. The algorithm is related to the classical multi-armed bandit problem, which is based on a slot machine with more than one arm. Each arm of the slot machine returns a reward of varying magnitude and each time the hypothetical player pulls an arm of the slot machine, the player must pay a set price. Once the player has pulled at least one arm, she examines the reward she has received from all of her past pulls, as well as the price the player has already paid and uses this information to decide which arm to pull next. The solution to the multi-armed bandit problem is a sequence in which to pull the arms of the slot machine that optimizes payout to the player.

This multi-armed bandit problem is similar to the problem of selecting content items to display on a portal page. There is an array of content items from which to select for display and, for each available spot on the page, one item is chosen to display. When a particular item is selected, the opportunity to display a different item is foregone, and thus each item selection comes with a set price. Choice of a particular item will produce a CTR of unknown magnitude. Thus, solutions to the multi-armed bandit problem are applicable to aid in selecting the order in which to present content items such that the order optimally converges to the highest possible payout. In the case of the portal page, the payout that is maximized is the click-through rate.

There are also some differences between the multi-armed bandit problem and the problem of content item selection for a portal page. The multi-armed bandit problem assumes immediate knowledge of the magnitude of the reward received by the player once an arm has been chosen and pulled. Thus, the decision of which arm to pull is based on all of the feedback from all of the previous pulls performed by the player. The assumption that all feedback will be available at every point of decision is not feasible in the case of presenting content items to visitors of a portal page because a visitor of the page, when presented with a content item, might not immediately click on the item. The visitor may do any number of things after viewing the content item, before deciding finally to click on the content item presented. Thus, one cannot assume that if a viewer does not click on a content item immediately, the viewer will never click on the content item. Also, in the case of a very large portal page, some time may be needed to gather and assemble information regarding the CTR.

Another difference between the problem of content selection and the multi-armed bandit problem is that the multi-armed bandit problem assumes a fixed set of arms available to be chosen. However, the set of content items available to be displayed on a portal page can change almost constantly.

Finally, the multi-armed bandit problem generally assumes that the magnitude of the reward for each arm is static. However, in the case of serving content items on a portal page, the CTR of an item may vary widely from day to day. For example, a content item about a movie that is to be released tomorrow could be very popular presently, but may lose its popularity overnight if it is a box-office flop.

Thus, in one embodiment of the invention, solutions to the multi-armed bandit problem are modified to address the particular issues of the content selection problem. In another embodiment of the invention, a new Bayesian explore/exploit algorithm is used to address these issues.

### Modification of Priority-Based Solutions to the Multi-Armed Bandit Problem

An embodiment of the invention is described below wherein the solution to the traditional multi-armed bandit algorithm is modified to include an experiment to produce hypothetical data pertaining to a future time period. Based on this modified solution, a plan is formulated for selecting content items to be served during the future time period that are most likely to maximize the CTR of the portal page.

The experiment includes identifying a set future time interval and hypothetically serving content items to hypothetical users that are assumed to visit the portal page during the future time interval. The number of visitors to the page during a particular period of time is estimated from historical data. For each hypothetical presentation of a content item, the expected click-through rate of the item and the number of times the item was hypothetically served is recorded in an experiment database. The definition of the expected click-through rate for an item used for the experiment is an empirical estimate based on the true historical data regarding the item. When the experiment is complete, the data from the experiment database is used to create a plan for serving the available content items to actual portal page visitors during the set time period.

In one embodiment of the invention, as information is gathered pertaining to the content items presented to actual users during the set time period, the true historical database is updated with the data gathered from the true user reactions. Then the experiment is run again to produce an updated plan for a new future time period. Thus, the data from the experiment is used in conjunction with the historical data to provide a larger set of data on which to base the selection of the content items than would be available if content items were selected based on the available historical data alone. In another embodiment of the invention, experiments regarding future time periods are run continuously while information is gathered pertaining to content items presented to actual users of the portal page. In this embodiment of the invention, the future time period is not set, but is constantly moving so as to provide an updated corpus of projected future data at all times.

The following is a more detailed discussion of one embodiment of the invention. In order to simplify this discussion, the subject portal page is assumed to have N content items available to display and the capacity to display only a single content item at a time. A particular item i has a current estimated probability, \hat{P}ᵢ, that a random user will click on the item. In one embodiment of the invention, \hat{P}ᵢ is estimated by dividing the total number of clicks observed for item i by the total number of times item i has been shown to users. In another embodiment of the invention, \hat{P}ᵢ uses both historical data and simulated data. One of skill in the art will appreciate that there are other ways to calculate \hat{P}ᵢ. Thus, if item i is served K times, K·\hat{P}ᵢ clicks on item i are expected.

A true historical database D holds the historical data pertaining to each of the N content items, including the number of times each item has been actually presented to users and the number of clicks that have been observed for each item. Historical database D is the basis for the experiment that produces the simulated data. In one embodiment of the invention, a priority function uses D to select which item to present hypothetically to hypothetical visitors during the set future time period, t. For each item in N, the priority function, f, receives the historical data pertinent to an item i, denoted Dᵢ, and outputs a number rank pertaining to item i based on that data. In one embodiment, the priority function is as follows:

f(Dᵢ)=\hat{P}ᵢ+V(Dᵢ)

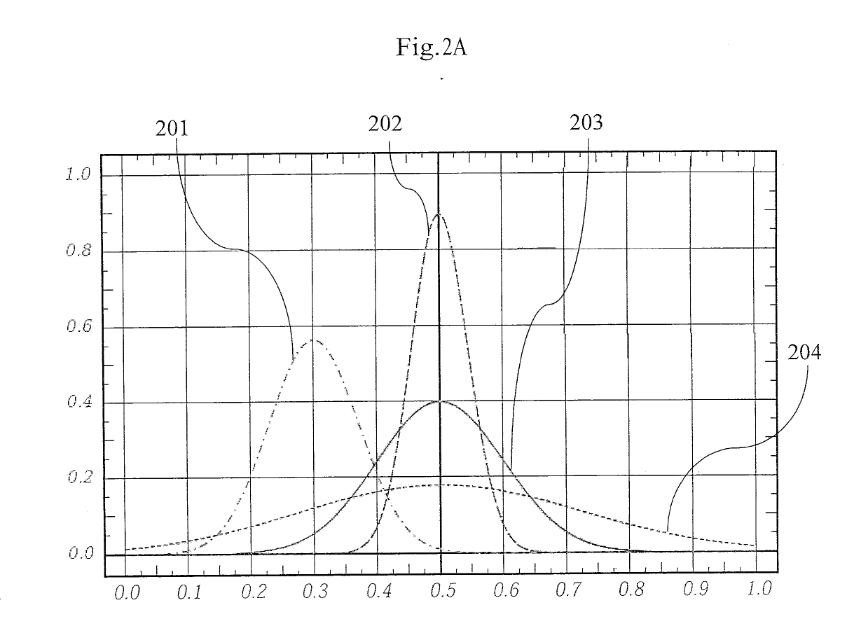

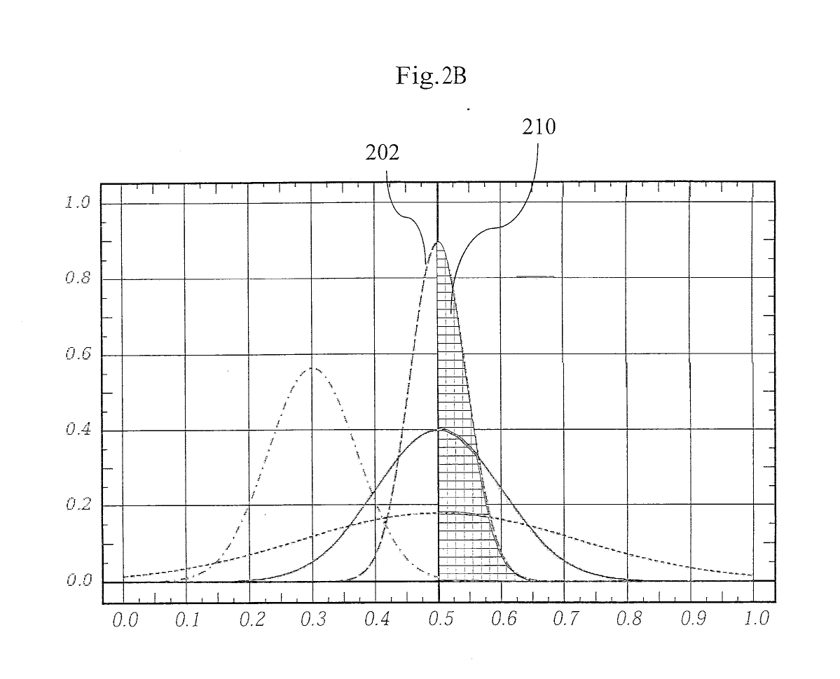

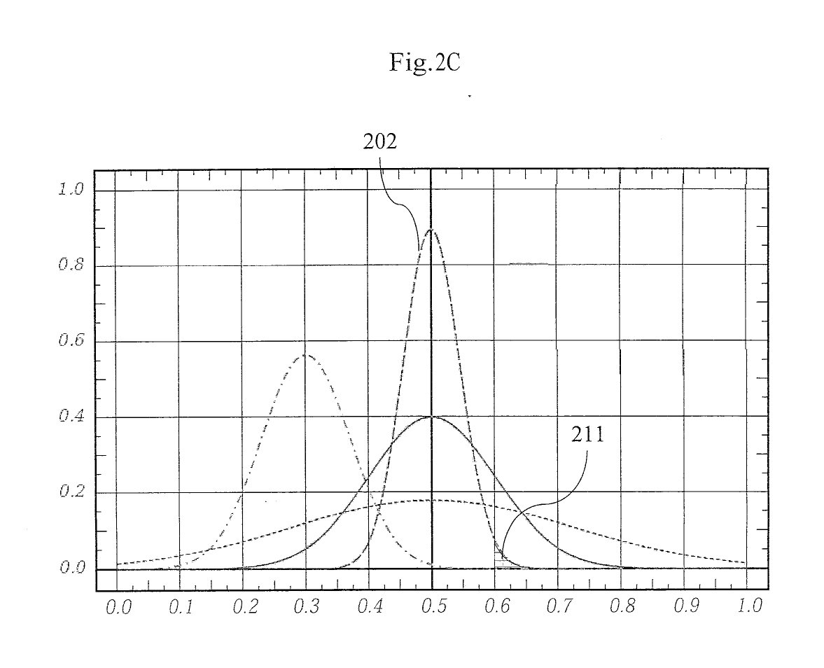

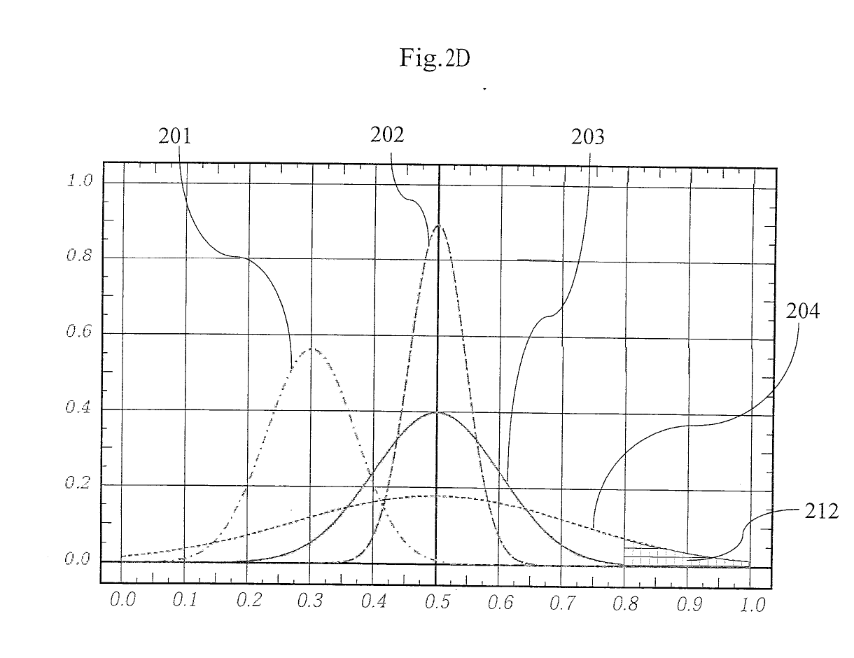

Thus, the priority of item i is calculated by adding its current estimated click-through rate, \hat{P}ᵢ, with V (Dᵢ), which is a variance calculation. For example, a quantity that intuitively represents variance is

$$\sqrt{\frac{2 ln n}{{n}_{i}}} ,$$

where n denotes the total number of page views served so far and nᵢ represents the number of pages given to item i so far. V (Dᵢ) represents an empirical estimate of the potential for the CTR of item i to improve. As a demonstration of why the variance should be considered, in FIG. 2A, probability distributions 201, 202, 203, and 204 are graphs approximating statistical models on which the variance for a particular item could be based. Specifically, FIG. 2B illustrates that probability distribution 202 indicates, at area 210, a 50% probability that the item corresponding to probability distribution 202 will achieve a CTR greater than 0.5. Also, FIG. 2C illustrates, at section 211, a 5% probability that the item corresponding to probability distribution 202 will achieve a CTR greater than 0.6. Because the probability function f involves both \hat{P}ᵢ and V (Dᵢ), the function takes into account the present estimated click-through rate and the probability that a click-through rate will improve in the future.

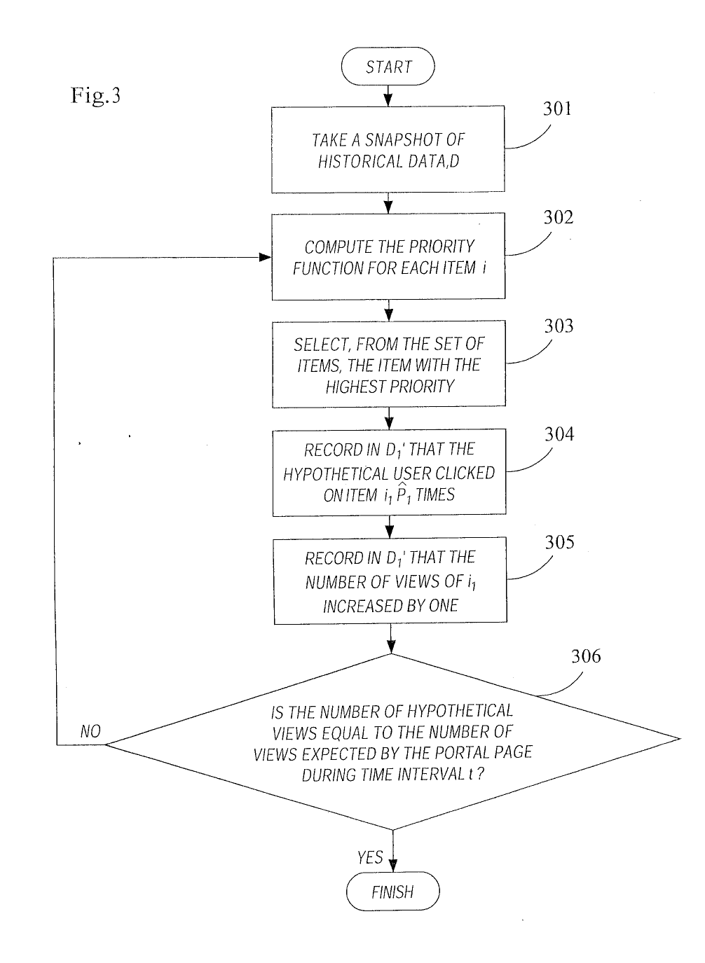

In one embodiment of the invention shown in FIG. 3, the first step 301 in deciding what to show for each visit in the designated future time period, t, is to take a snapshot of the entire set of historical data, D. Next, in step 302, the priority for each item is computed using the priority function, f as well as the historical data for each item i, Dᵢ and the experiment data gathered to this point for each item i, Dᵢ′. The priority function is evaluated as f(union of Dᵢ and Dᵢ′). In the case of the first item to be selected, the set of experiment data will be empty. In step 303, the item with the highest priority score, denoted i₁, is selected to be hypothetically served to a hypothetical user in the experiment. The hypothetical data set for item i₁, D′₁, is updated to reflect the hypothetical selection of item i₁. This update records the following: (1) that the hypothetical user clicked on item i₁ a fraction of times, equal to \hat{P}₁, at step 304, and (2) the number of views of item i₁ has increased by one, at step 305.

After the hypothetical data set D′₁ is updated, the simulation process repeats itself starting from step 302 until the number of hypothetical views by the simulation reaches the number of views that is expected at the portal page during time interval t, as illustrated in decision 306.

The above-described technique amounts to a simulation of user behavior for the future time period t. In one embodiment of the invention, the percentage of times each item was hypothetically served is used as a sampling plan. The content items are presented to users during the designated time period, t, based on the percentage corresponding to each item in the sampling plan.

For a non-limiting example of creating a sampling plan, the result of a particular experiment regarding a particular time interval is that item i₁ was presented hypothetically to hypothetical users two times out of ten, or 20% of the time, and item i₂ was presented hypothetically to hypothetical users eight times out of ten, or 80% of the time. For the purposes of the experiment, the subject time interval is a future time interval. However, when the sampling plan—created as a result of the experiment—is put into practice, the subject time interval is the present time. Thus, the plan created from the particular experiment indicates that item i₁ is to be presented to actual users 20% of the time during the subject time interval and that item i₂ is to be presented to actual users 80% of the time.

A more detailed discussion of the modification of priority-based solutions to the multi-armed bandit problem is located in Section 4 of Appendix A.

### Bayesian Solution

In another embodiment of the invention, the problem of selecting content for a portal page such that the CTR is maximized can be put into a Bayesian formula for which the optimal solution can be found. Again, this discussion focuses on CTR as the pertinent performance metric, but performance can be measured in other ways. This equation takes into account a changing content pool, a shifting CTR for each content item, and the delay between presenting a particular content item to a user and receiving feedback regarding the success of the particular content item. However, the solution for such an equation is calculation-intensive. Therefore, Lagrange relaxation and normal approximation are implemented in one embodiment of the invention to allow for calculation of a near-optimal solution of the equation in real time.

Each item in the content pool is associated with a probability distribution (for example, probability distributions 201-204 in FIG. 2A) measuring the potential for the CTR associated with the item to increase or decrease. As an illustration, probability distribution 201 represents an approximation of the probability distribution associated with item i₁, and probability distribution 202 represents an approximation of the probability distribution associated with item i₂.

The probability distribution associated with each item indicates the probability that an item will get a better or a worse click-through rate than that item's current CTR if the item continues to be served to users. Because the goal is to maximize the total click-through rate, focus is placed on the possibility of obtaining a better click-through rate as opposed to the possibility of producing a worse click-through rate. If, for example, item i₂ has a current estimated click-through rate of 0.5 (indicating that out of 10 views, item i₂ has been clicked on an average of 5 times), probability distribution 202 can be used to estimate the chance that users will click on item i₂ more often than 5 out of 10 times if the item continues to be presented to users. Probability distribution 202 shows a 50% chance that the click-through rate of item i₂ will improve from 0.5, as shown in FIG. 2B as an area 210 under the probability distribution 202.

Of particular interest is the area under the curve to the extreme right, known as the tail area, where the gain in click-through rate is potentially the greatest. This tail area is used herein for explanation purposes only; the Bayesian solution does not use or calculate the tail area. An example of a tail area is indicated in FIG. 2C by an area 211, which shows a probability of 5% that the click-through rate for item i₂, which is associated with probability distribution 202, could be higher than 0.6. Given a goal of maximizing the total CTR, the optimization problems discussed in the cases hereafter explore the possibility of a given item performing in the range of the tail area of that item's distribution, especially if the range of that tail area is better than the item with the best known click-through rate.

In one embodiment of the invention, the possibility that the other item will produce a higher CTR than the item with the current-best CTR is tested by serving the other item to users and monitoring the actual click-through rate of the other item. As more is known about the actual click-through rate of the other item, the probability distribution associated with the item changes, converging on a single CTR number. As the probability distribution converges, the tails area of the probability distribution gets smaller. If, as more information is gained about the items in the content pool, the probability distributions indicate that there is no longer a significant possibility that the other item will produce a higher CTR than the best known item's CTR, then the other item is no longer served. Conversely, if the other item continues to have a significant enough probability of producing a better CTR than the best known CTR, then the other item will continue to be presented to users.

In this manner, experiments are performed to get more information about the click-through rates of items with the potential to have very high click-through rates, to explore, for each item, the possibility that the item's click-through rate will improve. However, once the probability distribution indicates a poor probability of a particular item achieving a high click-through rate, the experiment with respect to the particular item is over.

### Single-Interval Case

The simplest problem setting in which to describe the Bayesian equation is one in which only one time interval is considered, called time interval 1. The goal is to determine the fraction of times that each available item is selected for presentation to users during time interval 1, which fraction is denoted by x_{i,1} for each item i, such that the total number of clicks in time interval 1 is maximized. In this scenario, the maximum number of clicks is obtained by assigning 100% of the page views to the item with the highest expected CTR.

### Bayes 2×2 Case: Two Items, Two Intervals

A slightly more involved scenario is one in which two items are available to display to the user and two time intervals, T₀ and T₁, are remaining. In order to further simplify the scenario, the CTR of the first item is exactly known without uncertainty. The known and certain CTR of the first item is denoted by q₀ and q₁, in time intervals T₀ and T₁, respectively, as indicated by the subscripts of the respective variables. The uncertain CTR of the second item is denoted by p₀˜P(θ₀) and p₁˜P(θ₁) in time intervals T₀ and T₁, respectively. P(θₜ) is a posterior distribution of pₜ and θₜ is a vector representing the hyperparameter or state of the distribution. The vector represented by θ₀ is a known quantity, while the vector represented by θ₁ is random because it is a function of a random number of clicks obtained in interval 0. Furthermore, N₀ and N₁ denote the number of respective page views for each time interval and x and x₁ denote the fraction of page views to be given to the uncertain item. The quantities (1−x) and (1−x₁) are the fractions to be given to the certain item. The variable c denotes a random variable representing the number of clicks that the uncertain item gets in time interval 0. Finally, \hat{p}ₒ=E[p₀] and \hat{p}₁(x, c)=E[p₁|x, c].

The value of x₁ depends on x and c. To emphasize that xi is a function of x and c, x₁ is at times expressed as 0≦x₁(x, c)≦1. Let X₁ denote the domain of x₁, which is the set of all possible such functions that return a number between 0 and 1 for given (x, c). The goal is to find xε[0, 1] and x₁εX₁ that maximize the expected total number of clicks in the two time intervals, which maximization problem is denoted by:

$$E [ {N}_{0} ( {xp}_{0} + ( 1 - x ) {q}_{0} ) + {N}_{1} ( {x}_{1} {p}_{1} + ( 1 - {x}_{1} ) {q}_{1} ) ] = E [ {N}_{0} x ( {p}_{0} - {q}_{0} ) + {N}_{1} {x}_{1} ( {p}_{1} - {q}_{1} ) ] + {q}_{0} {N}_{0} + {q}_{1} {N}_{1} . \qquad Eq . 1$$

Since q₀N₀ and q₁N₁ are constants, only the expectation term, E[N₀x(p₀−q₀)+N₁x₁(p₁−q₁)], needs to be maximized. Therefore, like in the previous scenario, the goal is to determine the fraction of times to display each item such that the total number of clicks is maximized. In other words, x and x₁ must be determined such that the following equation is maximized:

Gain(x,x₁)=E[N₀x(p₀−q₀)+N₁x₁(p₁−q₁)], Eq. 2

which is the difference in the number of clicks between: (a) a scheme that shows the uncertain item for xN₀ times in interval 0 and x₁N₁ times in interval 1 and (b) a scheme that always shows the certain item for 100% of page views.

Therefore, given that the maximum number of clicks is obtained by assigning 100% of the page views to the item with the highest expected CTR, as derived in the single-interval case above, the maximum of the Gain formula in Eq. 2, given θ₀, q₀, q₁, N₀, and N₁ is derived to be the following:

$${max}_{x ∈ [ 0 , 1 ] , {x}_{1} ∈ {X}_{1}} Gain ( x , {x}_{1} ) = {max}_{x ∈ [ 0 , 1 ]} Gain ( x , {θ}_{0} , {q}_{0} , {q}_{1} , {N}_{0} , {N}_{1} ) , \\ where$$

$$Gain ( x , {θ}_{0} , {q}_{0} , {q}_{1} , {N}_{0} , {N}_{1} ) = {N}_{0} x ( {\hat{p}}_{0} - {q}_{0} ) + {N}_{1} {E}_{c} [ max \{ {\hat{p}}_{1} ( x , c ) - {q}_{1} , 0 \} ] .$$

The variables \hat{p}₀ and \hat{p}₁(x, c) are functions of θ₀. The above equation is possible because time interval 1 is the last interval, and by the discussion in connection with the single-interval case above, when the gain is maximized, x₁(x, c) would either be 0 or 1 depending on whether \hat{p}₁(x, c)−q₁>0, for any given x and c. Also, because θ₀, q₀, q₁, N₀ and N₁ are constants, Gain(x, θ₀, q₀, q₁, N₀, N₁) can be simply written as Gain(x).

### Normal Approximation

Therefore, the optimal solution for the Bayes 2×2 case described above is

$${max}_{x ∈ [ 0 , 1 ]} Gain ( x , {θ}_{0} , {q}_{0} , {q}_{1} , {N}_{0} , {N}_{1} ) .$$

For a given class of probability distribution P of the number of clicks to be observed in time interval 0, the optimal x can be solved numerically. In the following discussion, P is taken to be either a Beta-Binomial distribution or a Gamma-Poisson distribution. It will be apparent to those of skill in the art that P could be taken as any one of a number of probability distribution types within the embodiments of this invention.

As an example, if p₀˜Beta(α, γ) (or Gamma(α, γ)), i.e., θ₀=[α, γ], and (c|p₀, xN₀)˜Binomial(p₀, xN₀) or Poisson(p₀xN₀), then \hat{p}₀=α/γ=and \hat{p}₁(x, c)=(a+c)/(γ+xN₀). Therefore, the gain function becomes the following:

$${N}_{0} x ( α / γ - {q}_{0} ) + {N}_{1} {\sum }_{c \geq ( γ + {xN}_{t} ) {q}_{1} - α} Pr ( c \vert α , γ , {xN}_{0} ) ( \frac{α + c}{γ + {xN}_{t}} - {q}_{1} ) , \qquad Eq . 4$$

where Pr(c|α, γ, xN₀) is the probability mass function of the Beta-Binomial (or Gamma-Poisson) distribution. The range of the above summation is c≧(γ+xNₜ)q₁−αiff \hat{p}₁(x, c)−q₁≧0.

The following is a discussion of a normal approximation used in one embodiment of the invention to facilitate computation of the Bayesian solution. This normal approximation is based on an assumption that the function \hat{p}₁(x, c), which is a function of random variable c, is normally distributed. The variance of p₀ is denoted by σ²₀ such that

$${σ}_{0}^{2} = \frac{α ( γ - α )}{{γ}^{2} ( 1 + γ )}$$

for a Beta-Binomial distribution and σ₀²=α/γ² for a Gamma-Poisson distribution. Straightforward derivation reveals the following:

$$\begin{matrix}E [ {\hat{p}}_{1} ( x , c ) ] = {\hat{p}}_{0} = α / γ , Var [ {\hat{p}}_{1} ( x , c ) ] \\ = {{σ}_{1} ( x )}^{2} ≡ \frac{{xN}_{0}}{γ + {xN}_{0}} {σ}_{0}^{2} .\end{matrix}$$

In other words, it is assumed that \hat{p}₁(x, c)˜N(\hat{p}₀,σ₁(x)²).

Therefore, if φ and Φ denote the density and distribution functions of the standard normal distribution, then

$$Gain ( x , {θ}_{0} , {q}_{0} , {q}_{1} , {N}_{0} , {N}_{1} ) = {N}_{0} x ( {\hat{p}}_{0} - {q}_{0} ) + {N}_{1} [ {σ}_{1} ( x ) φ ( \frac{{q}_{1} - {\hat{p}}_{0}}{{σ}_{1} ( x )} ) + ( 1 - Φ ( \frac{{q}_{1} - {\hat{p}}_{0}}{{σ}_{1} ( x )} ) ) ( {\hat{p}}_{0} - {q}_{1} ) ] .$$

Again, to simplify notations, Gain(x, θ₀, q₀, q₁, N₀, N₁) is written as Gain(x). The first and second derivatives of Gain(x), used to find the x that maximizes Gain(x), are as follows:

$$\begin{matrix}\frac{d}{d x} Gain ( x ) = {N}_{0} ( {\hat{p}}_{0} - {q}_{0} ) + \frac{{N}_{1} {σ}_{0} γ {N}_{0}^{1 / 2}}{2 {{x}^{1 / 2} ( γ + {xN}_{0} )}^{3 / 2}} φ ( \frac{{q}_{1} - {\hat{p}}_{0}}{{σ}_{1} ( x )} ) \\ \frac{{d}^{2}}{d {x}^{2}} Gain ( x ) = A ( x ) [ - 4 {N}_{0} {x}^{2} + γ ( {B}^{2} - 1 ) x + {B}^{2} {γ}^{2} {N}_{0}^{- 1} ] ,\end{matrix}$$

$$where$$

$$A ( x ) = \frac{{N}_{1} {σ}_{0} γ {N}_{0}^{1 / 2}}{4 {{x}^{5 / 2} ( γ + x {N}_{0} )}^{5 / 2}} φ ( \frac{{q}_{1} - {\hat{p}}_{0}}{{σ}_{1} ( x )} ) , and B = ( {q}_{1} - {\hat{p}}_{0} ) / {σ}_{0} .$$

Also, for convenience, the following is defined:

C=(γ/8N₀)(B²−1+[(B²−1)²+16B²]^{1/2}).

The equation represented by C is the only solution for x to

$$\frac{{d}^{2}}{d {x}^{2}} Gain ( x ) = 0 , for x > 0 ,$$

if the solution exists.

The function

$$\frac{d}{d x} Gain ( x )$$

is decreasing x for C<x<1. The variable x* denotes the unique solution, if such solution exists, to

$$\frac{d}{d x} Gain ( x ) = 0 for C < x < 1.$$

Therefore, max_{xε[0,1]} Gain(x) achieves the maximum at x=0, x=1, or x=x*, if x* exists.

The optimal solution to the above case is max_{xε[0,1]} Gain(x), the maximum of which is x*, if x* exists, as discussed above. Because

$$\frac{d}{d x} Gain ( x )$$

is decreasing, a binary search can be applied to find x*, which is the x between C and 1, such that

$$\frac{d}{d x} Gain ( x ) = 0.$$

### Bayes K×2 Case: K Items, Two Intervals

The Bayes 2×2 case described above can be extended to a case encompassing two time intervals with K items available to be displayed to users of the portal web page, without the need to distinguish between items with certain CTR and items with uncertain CTR. The optimal solution to this K×2 case can be defined, but finding the optimal solution is computationally challenging. Thus, the Lagrange relaxation technique is applied to find a near optimal solution. While the Lagrange relaxation technique is well-known, the application of this technique to this Bayes K×2 case is novel.

As indicated above, p_{i,t}˜P(θ_{i,t}) denotes the CTR of item i at time tε{0,1}. The expected value of p_{i,t} is denoted by μ(θ_{i,t})=E[p_{i,t}], which is a function of θ_{i,t}, θₜ=[θ_{1,t} . . . , θ_{K,t}] represents the joint state of all items at time t, and the variable x_{i,t} represents the fraction of page views to be given to item i at time t. As with the previous cases, the goal is to determine x_{i,0} and x_{i,1}, for all i, in order to maximize the total number of clicks in the two time intervals. The variable x₁ is used to generally denote [x_{1,t}, . . . , x_{K,t}]. These initial decisions are based on a known θ₀. However, θ₁ is not known because θ₁ depends on x₀ and the numbers of clicks, c₀=[c_{1,0}, . . . , c_{K,0}], which the items will receive after the items are served according to x₀.

The numbers that each x_{i,0} represents is between 0 and 1. In contrast, each x_{i,1} represents a function of x₀ and c₀. Also, it is assumed that, for any θ₀, each (x₀, c₀) uniquely identifies a next state θ₁(x₀, c₀). This is true for many common models, e.g., the Beta-Binomial model. Thus, it follows that x_{i,1} can be considered as a function of θ₁(x₀, c₀). To emphasize this idea, x_{i,1} is sometimes referred to in this description as x_{i,1}(θ₁).

The expected total number of clicks in the two time intervals is

R(x, θ₀, N₀, N₁)=NΣᵢx_{i,0}μ(θ_{i,0})+N₁ΣᵢE_{θ}_{₁}[x_{i,1}(θ₁)μ(θ_{i,1})].

The goal is to find

$${R}^{*} ( {θ}_{0} , {N}_{0} , {N}_{1} ) = {max}_{0 \leq x \leq 1} R ( x , {θ}_{0} , {N}_{0} , {N}_{1} ) ,$$

subject to Σᵢx_{i,0}=1 and Σᵢx_{i,1}(θ₁)=1, for all possible θ₁. Without the above constraints, R(x, θ₀, N₀, N₁) would be maximized by setting every x_{i,t} to 1.

### Lagrange Relaxation

To make the above optimization computationally feasible, the constraints on interval 1 are relaxed using the Lagrange relaxation technique. As discussed above, the optimization problem of the Bayes K×2 case is subject to a strict constraint: Σᵢx_{i,1}(θ₁)=1, for all possible θ_{1.} Again, this constraint requires that the sum of all of the x_{i,1} for each of the K items equal one. The difficulty is that the constraint is for every possible value of θ₁, which translates into a constraint per possible value of θ₁. Lagrange relaxation replaces that huge number of constraints with a single constraint, that is E_{θ}_{₁}Σᵢx_{i,1}(θ₁)=1. This is a single constraint, instead of a constraint per possible value of θ₁.

More specifically, Lagrange relaxation substitutes the above-mentioned strict requirement that Σᵢx_{i,1}(θ₁)=1, for all possible θ₁, with the requirement that Σᵢx_{i,1}(θ₁)=1 on average. Thus, the optimization problem becomes:

$${R}^{+} ( {θ}_{0} , {N}_{0} , {N}_{1} ) = {max}_{0 \leq x \leq 1} R ( x , {θ}_{0} , {N}_{0} , {N}_{1} ) ,$$

subject to Σᵢx_{i,0}=1 and Σ_{θ}_{₁}Σᵢxi,1(θ₁)=1.

This relaxed constraint is less exact than the original strict constraint, but the relaxed constraint is a good approximation of the original constraint. The relaxed constraint is also easier to compute than the original constraint. While the solution found with the relaxation technique may not be the optimal solution, the solution is close enough to optimal to warrant using the relaxation to make the calculations faster.

The Lagrange multiplier technique is a common technique used to handle constrained optimization problems like this, however application of the technique is new in the context of batched serving. The objective function is redefined by including the constraints, and then the resulting unconstrained problem is solved. The following variables are defined:

$$V ( {θ}_{0} , {q}_{0} , {q}_{1} , {N}_{0} , {N}_{1} ) = {max}_{0 \leq x \leq 1} \{ \begin{matrix}R ( x , {θ}_{0} , {N}_{0} , {N}_{1} ) - {q}_{0} {N}_{0} ( {Σ}_{i} {x}_{i , 0} - 1 ) - \\ {q}_{1} {N}_{1} ( E [ {Σ}_{i} {x}_{i , 0} ] - 1 )\end{matrix} \} ,$$

where q₀ and q₁ are the Lagrange multipliers. By the theory of Lagrange multipliers, under mild regulatory conditions,

$${R}^{+} ( {θ}_{0} , {N}_{0} , {N}_{1} ) = {min}_{{q}_{0} , {q}_{1}} V ( {θ}_{0} , {q}_{0} , {q}_{1} , {N}_{0} , {N}_{1} ) .$$

There are two important properties of the V function described above that significantly simplify the computation of the Bayes K×2 case: convexity and separability.

The equation V(θ₀, q₀, q₁, N₀, N₁) is convex in (q₀, q₁). Because V is convex in (q₀, q₁), standard non-differential convex optimization tools can be used to find the minimum solution. Now, the question is, given (q₀, q₁), how to compute the V function efficiently.

With regard to the separability property, the following equation applies:

$$V ( {θ}_{0} , {q}_{0} , {q}_{1} , {N}_{0} , {N}_{1} ) = {\sum }_{i} ( {max}_{0 \leq {x}_{i , 0} \leq 1} Gain ( {x}_{i , 0} , {θ}_{i , 0} , {q}_{0} , {q}_{1} , {N}_{0} , {N}_{1} ) ) + {q}_{0} {N}_{0} + {q}_{1} {N}_{1} .$$

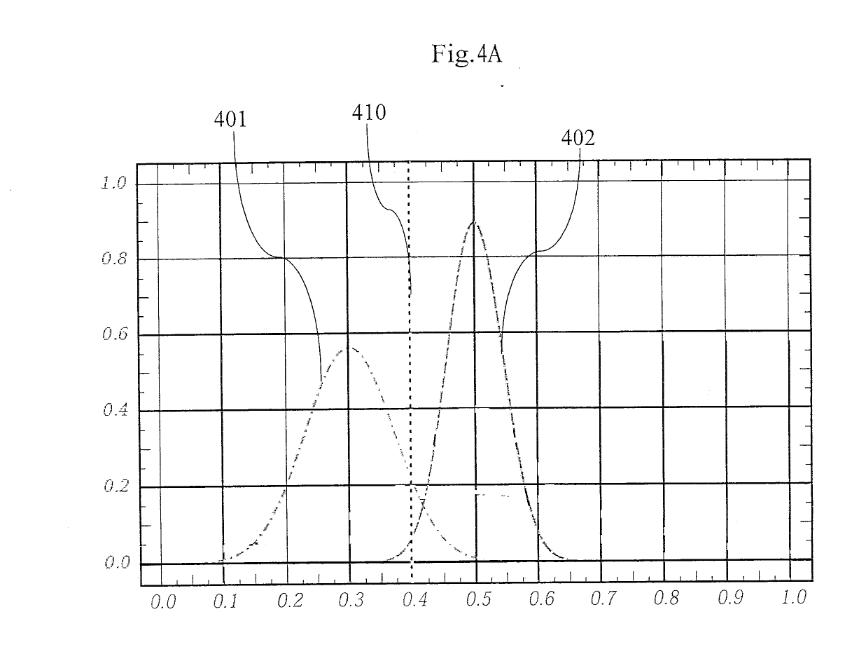

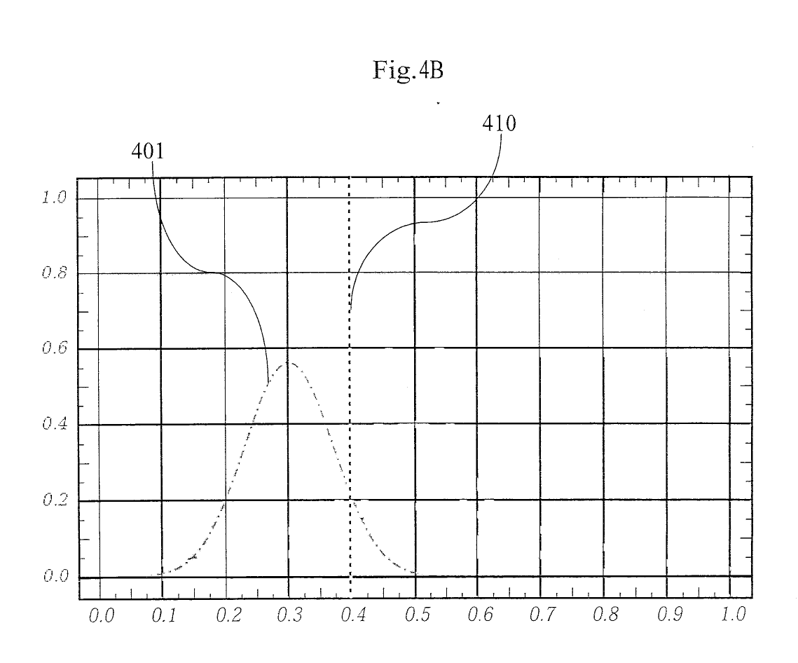

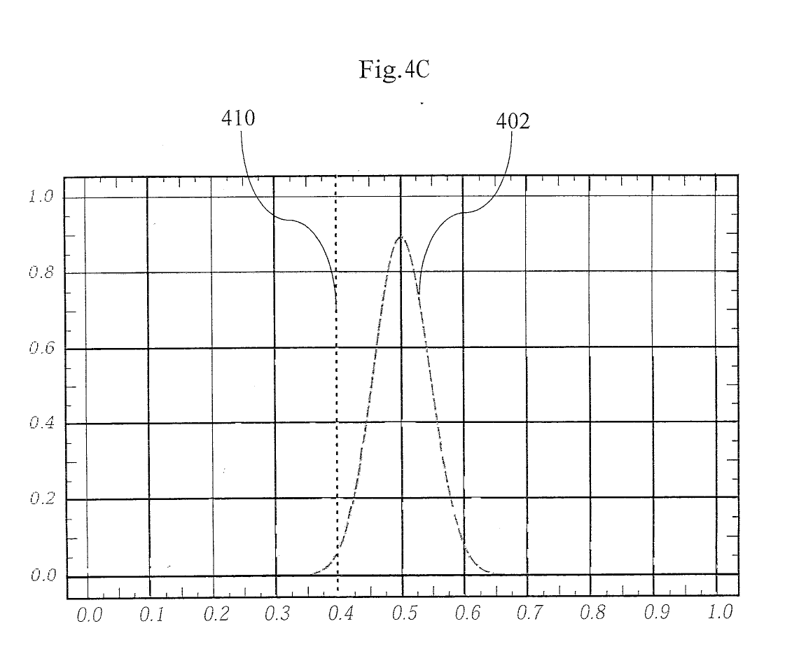

The separability property is important for efficient computation. Because of this property, maximization (over x_{i,0}) can be done for each item i independently to compute the V function. Generally, the problem of comparing probability distributions associated with content items in order to select the item with the greatest probability of a high click-through rate is a very complex problem. To split this calculation up into smaller calculations, the relaxed constraint introduces a representation of a hypothetical CTR associated with a hypothetical content item about which everything is known. Instead of having a probability distribution, this hypothetical item has an exact CTR value. For example, in FIG. 4A, a dotted line 410 represents a hypothetical item with a known click-through rate of 0.4. Instead of comparing probability distributions 401 and 402 to each other, the Lagrange relaxation technique allows the probability distribution for each item to be compared separately to hypothetical item 410, as is illustrated in FIG. 4B and FIG. 4C. In FIG. 4B, probability distribution 401 is compared to hypothetical item 410, and in FIG. 4C, probability distribution 402 is compared to hypothetical item 410.

Each problem represented by FIGS. 4B and 4C can be computed separately because they hypothetical item 410 is the same in each separate computation. As such, the hypothetical item 410 preserves the relative qualities of the different probability distributions 401 and 402. The inter-dependencies between each item's probability distribution is captured by the hypothetical item 410. Thus, in a system with K items, like the general case described below, the Lagrange relaxation changes what would be a K-dimensional optimization problem into K problems of one dimension.

This independent maximization reduces to the gain maximization discussed in connection with the Bayes 2×2 case and can be solved efficiently. Without the separability property, computation of function V involves joint maximization (over x_{1,0}, . . . , x_{K,0} jointly), which would have to be done in a K-dimensional space. Even if function V is concave (which may not be true) in x_{1,0}, . . . , x_{K,0}, this joint maximization is expensive.

Therefore, the near optimal solution attained using Lagrange relaxation is computationally feasible, and thus preferable to the exact optimal solution attained without Lagrange relaxation. To decide what fraction of page views is given to each item i in the next interval (interval 0), a standard convex optimization tool is used to compute min_{q}_{₀}_{,q}_{₁} V (θ₀, q₀, q₁, N₀, N₁). The variables q₀* and q₁* denote the minimum solution. Then,

$${x}_{i , 0}^{*} = arg {max}_{0 \leq {x}_{i , 0} \leq 1} Gain ( {x}_{i , 0} , {θ}_{i , 0} , {q}_{0}^{*} , {q}_{1}^{*} , {N}_{0} , {N}_{1} )$$

is the fraction of page views to be given to item i during the future time interval.

### General Solution to the Bayesian Optimization Problem

The solution for the general case is discussed, in which there is a dynamic set of items and non-stationary CTR. This general solution is a generalization of the Bayes K×2 solution discussed above, and one embodiment of the invention involves a two-stage approximation for multiple time intervals. As such, this general case involves K items and T+1 future time intervals (t=0, . . . , T). It is assumed that all of these K items are available in every future time interval. Similar to the bayes K×2 case after Lagrange relaxation is applied, the convexity and separability properties still hold (though the formulas need to be slightly modified). However, the computational complexity increases exponentially in T. Because a scalable serving method is desirable, the T+1 interval case is approximated by only considering two stages: The first stage (indexed by 0) contains interval 0 with N₀ page views, while the second stage (indexed by 1) contains the rest of the T time intervals with Σ_{1ε[1,T]}N, page views. The second stage is treated similarly to the second time interval in the Bayes 2×2 case. Thus, the approximate solution is obtained by solving the Bayes 2×2 case where N₁ is replaced by Σ_{1ε[1,T]}Nₜ.

The general solution case takes into account a dynamic set of items. Items in a content optimization system come and go. For example, to ensure freshness, a business rule might specify that the lifetime of each item available to be presented to users is at most one day. Thus, the decision of what fraction of page views to allocate to each item logically focuses on the set of live items in the next time interval (indexed by 0). Generally, the solution to the present case is to apply the two-stage approximation to each individual item such that the lifetime constraint of each item is also satisfied. The theoretical justification is that the separability property still holds if the lifetime constraint for each item is included in the calculation.

The quantities start(i) and end(i) denote the start interval and end interval of item i. The variable I₀ denotes the set of live items, which are items i with start(i)≦0. The variable T=max_{iεI}_{₀} end(i) denotes the end time of the item in I₀ having the longest lifetime. Variable I⁺ denotes the set of items i with 1≦start(i)≦T, which are also called future items. For ease of exposition, end_{T}(i) represents min{T, end(i)}. The two-stage approximation is extended to include item lifetime constraints by modifying the V function, discussed in connection with Lagrange relaxation above, as follows:

$$V ( {θ}_{0} , {q}_{0} , {q}_{1} , {N}_{0} , … , {N}_{T} ) = {\sum }_{i ∈ {I}_{0}} {max}_{0 \leq {x}_{i , 0} \leq 1} Gain ( {x}_{i , 0} , {θ}_{i , 0} , {q}_{0} , {q}_{1} , {N}_{0} , {\sum }_{t = 1}^{{end}_{T} ( i )} {N}_{t} ) + {\sum }_{i ∈ {I}^{+}} {max}_{0 \leq {y}_{i} \leq 1} Gain ( {y}_{i} , {θ}_{i , 0} , {q}_{1} , {q}_{1} , {N}_{start ( i )} , {\sum }_{t = start ( i ) + 1}^{{end}_{T} ( i )} {N}_{t} ) + {q}_{0} {N}_{0} + {q}_{1} {\sum }_{t ∈ [ 1 , T ]} {N}_{t}$$

Standard convex minimization techniques are applied to find the q₀* and q₁* that minimize the above V function. The x_{i,0} that maximizes the Gain function at q₀=q₀* and q₁=q₁* is the fraction of page views to be given to item i in the next time interval. The above V function is now expounded.

Live items (I₀) require different treatment than future items (I⁺). Thus, there are two separate summation terms. The two-stage approximation is applied for each item. For a live item i, time interval 0 is the first stage, while the second stage includes time intervals 1, . . . , end_{T}(i). For a future item i, the first stage is start(i)≠0, and the second stage includes intervals start(i)+1, . . . , end_{T}(i). Again, the goal is to determine what fraction x_{i,0} of page views should be given to each live item i in the immediate next interval (interval 0). Therefore, a different variable, i.e., yᵢ, is used to denote the first-stage decision for future item i, which enters the system later than interval 0.

With respect to Lagrange multipliers, q₀ is used to ensure that Σ_{iεI}_{₀}x_{i,0}=1 for live items. Because future items are not available in interval 0, their gains do not include q₀. The variable q₁ is used to ensure that the expected total number of page views given to items between interval 1 and T in the optimization matches the actual number of page views (i.e., Σ_{tε[1,T]}Nₜ). Thus, q₁ is in both gain functions. Furthermore, in the gain function for future items, there are two occurrences of q₁ because both stages for future items are between interval 1 and T.

With respect to item lifetime the following expressions,

$${N}_{0} , {\sum }_{t = 1}^{{end}_{T} ( i )} {N}_{t}$$

(in the
gain function of live items) and

$${N}_{start ( i )} , {\sum }_{t = start ( i ) + 1}^{{end}_{T} ( i )} {N}_{t}$$

(in the gain function of future items) incorporate item lifetimes into the optimization.

With respect to prior distribution, θ_{i,0} represents the current belief about the CTR of item i. For live items, θ_{i,0} is the current state, which has been updated by all of the observed clicks by users in the past. For future items, there are no observations. Thus, θ_{i,0} is estimated (or initialized) based on analysis of historical data.

The approach to non-stationary CTR is by using dynamic models. When the state is updated from θ_{i,t} to θ_{i,t+1} after observing c_{i,t} clicks in x_{i,t}Nₜ page views, instead of assuming that the CTRs of item i at time t and t+1 are the same, the CTRs are allowed to have small changes. In one embodiment of the invention, exponentially weighted Beta-Binomial (EWBB) and Gamma-Poisson (EWGP) models are used for handling non-stationary CTR. Under these models, CTR is p_{i,t}˜Beta(α, γ) or Gamma(α, γ), i.e., θ_{i,t}=[α, γ], where α and γ can be thought of as the number of clicks and the number of views that were observed in the past for item i. After observing c clicks in ν page views, if CTR does not change over time, the state is updated by θ_{i,t}+1=[α+c, γ+ν].

The EWBB and EWGP models are simple. The variable w, such that 0≦w≦1, is a user-specified weight that needs to be tuned. The state is updated by θ_{i,t+1}=[ωα+c, ωγ+ν]. If w is set to 0, then the instant CTR is tracked by ignoring all the past observations. This is an unbiased estimate of the current state, but the variance (uncertainty) would be large unless the item is allocated a large number of page views in time t. If w is set to 1, then this setting practically assumes a stationary CTR. In this case, although variance is reduced by using all the past observations, the estimate of current state is biased toward the past. A good w value needs to be found based on application-specific characteristics and analysis of historical data. The difference between EWBB and EWGP is in the way that the variance is computed.

Using the EWBB/EWGP model in the Bayesian framework set forth in the embodiments of the invention is also simple. For each interval, after observing users' actual clicks, the EWBB/EWGP model is used to update the state of each item. Also, in the gain function computation discussed in connection with the Bayes 2×2 case—which is used in the two-stage approximation for the general case—α and γ are down-weighted in the second interval by ω. Specifically, in the normal approximation, the following is redefined as stated:

$$Var [ {\hat{p}}_{1} ( x , c ) ] = {{σ}_{1} ( x )}^{2} ≡ \frac{{xN}_{0}}{w γ + {xN}_{0}} {σ}_{0 w}^{2} ,$$

where

$${σ}_{0 w}^{2} = \frac{α ( γ - α )}{{γ}^{2} ( 1 + w γ )}$$

### for EWBB and

$${σ}_{0 w}^{2} = \frac{α}{w {γ}^{2}}$$

### for EWGP.

A more detailed discussion of the solution to the Bayesian optimization problem is located in Section 3 of Appendix A.

### Hardware Overview

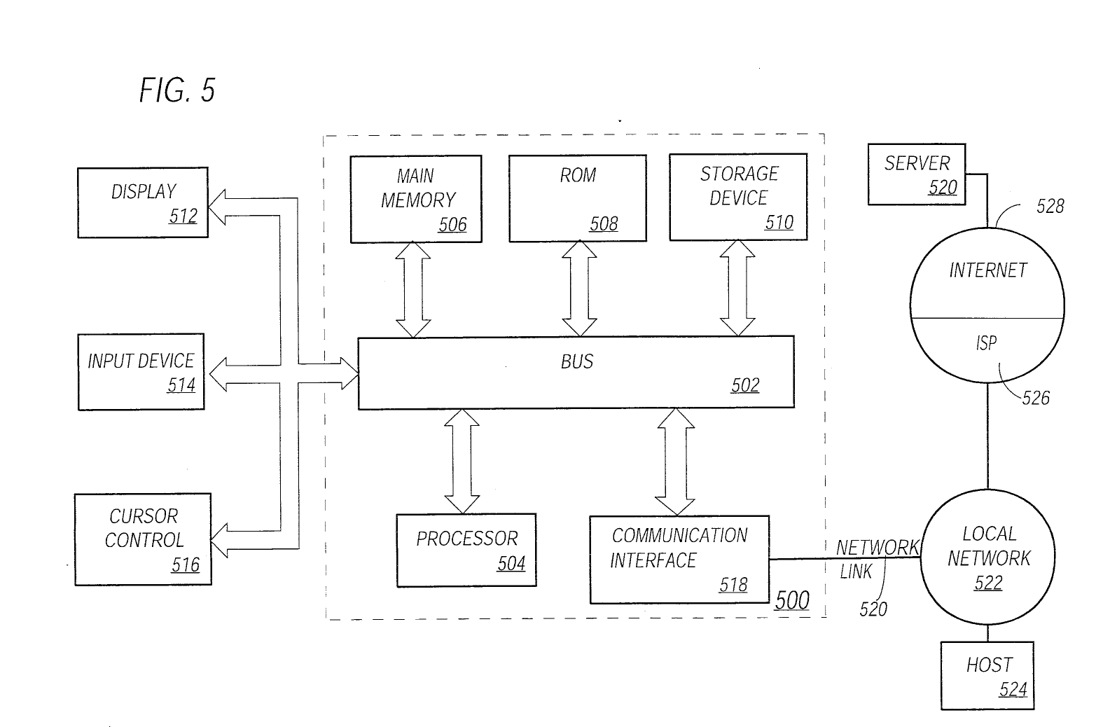

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to storage media and transmission media. Storage media includes both non-volatile media and volatile media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising the steps of:
solving an optimization problem to project user behavior pertaining to a display of a plurality of items during a specified future time period;
wherein the optimization problem is based on a relaxed formula that is a version of an original formula in which an original constraint from the original formula is replaced by a relaxed constraint in the relaxed formula;
wherein the relaxed constraint is less restrictive than the original constraint;
wherein the plurality of probability distributions pertain to a performance metric; and
selecting a particular item of the plurality of items during the specified future time period based on a solution to the optimization problem.

2. The computer-implemented method of claim 1, wherein the relaxed formula comprises an approximation of a measure of each probability distribution of a plurality of probability distributions.

3. The computer-implemented method of claim 1
wherein the relaxed formula uses a measurement of an observed user behavior; and
wherein the observed user behavior comprises a number of times the plurality of items have been viewed by a plurality of users and a number of times each item of the plurality of items has been selected by a user of the plurality of users.

4. The computer-implemented method of claim 1 wherein the plurality of items is changeable.

5. The computer-implemented method of claim 1
wherein each item of the plurality of items is associated with a probability distribution of the plurality of probability distributions;
wherein the probability distribution represents a dynamic performance metric; and
wherein a probability distribution associated with a particular item of the plurality of items changes over time.

6. The computer-implemented method of claim 5 wherein the relaxed formula incorporates a delay between when the item is selected for the display and when the dynamic performance metric can be updated with a result of the display.

7. The computer-implemented method of claim 5 wherein the dynamic performance metric comprises a click-through rate, a total number of page views over time, or a measure of overall user experience.

8. The computer-implemented method of claim 5 wherein the selecting the item during the specified future time period based on the solution to the optimization problem comprises selecting an item that will maximize the dynamic performance metric for the specified future time period.

9. The computer-implemented method of claim 1 further comprising the steps of:
storing, on a non-volatile or volatile computer-readable storage medium, the particular item of the plurality of items; and
presenting the particular item of the plurality of items to a user.

10. The computer-implemented method of claim 3 further comprising the steps of:
estimating a current value on the performance metric for a particular item of the plurality of items;
estimating a probability of improvement of the current value based on the step of solving the optimization problem to project user behavior;
basing a percentage of future page views to dedicate to the particular item based on the probability of improvement of the current value.

11. The computer-implemented method of claim 1, wherein the solution to the optimization problem comprises probabilities that each item of the plurality of items will be presented to a plurality of users during the specified future time period.

12. The computer-implemented method of claim 10, further comprising the steps of:
presenting, to the user, the particular item of the plurality of items based on the percentage of future page views to dedicate to the particular item;
wherein the step of presenting, to the user, the particular item occurs after solving the optimization problem to project user behavior.

13. The computer-implemented method of claim 10, further comprising the steps of:
presenting, to the user, the particular item of the plurality of items based on the percentage of future page views to dedicate to the particular item,
wherein the step of presenting, to the user, the particular item occurs during solving the optimization problem to project user behavior.

14. The computer-implemented method of claim 1 wherein the solution to the optimization problem pertains to users of a portal page on an Internet.

15. The computer-implemented method of claim 2,
wherein the approximation of the measure of the dynamic performance metric comprises a normal approximation; and
wherein the original constraint from the original formula is replaced by the relaxed constraint in the relaxed formula according to Lagrange relaxation.

16. A volatile or non-volatile computer-readable storage medium carrying one or more sequences of instructions which, when executed by one or more processors, cause the one or more processors to perform the steps recited in claim 1.

17. A volatile or non-volatile computer-readable storage medium carrying one or more sequences of instructions which, when executed by one or more processors, cause the one or more processors to perform the steps recited in claim 2.

18. A volatile or non-volatile computer-readable storage medium carrying one or more sequences of instructions which, when executed by one or more processors, cause the one or more processors to perform the steps recited in claim 3.

19. A volatile or non-volatile computer-readable storage medium carrying one or more sequences of instructions which, when executed by one or more processors, cause the one or more processors to perform the steps recited in claim 4.

20. A volatile or non-volatile computer-readable storage medium carrying one or more sequences of instructions which, when executed by one or more processors, cause the one or more processors to perform the steps recited in claim 5.

21. A volatile or non-volatile computer-readable storage medium carrying one or more sequences of instructions which, when executed by one or more processors, cause the one or more processors to perform the steps recited in claim 6.

22. A volatile or non-volatile computer-readable storage medium carrying one or more sequences of instructions which, when executed by one or more processors, cause the one or more processors to perform the steps recited in claim 7.

23. A volatile or non-volatile computer-readable storage medium carrying one or more sequences of instructions which, when executed by one or more processors, cause the one or more processors to perform the steps recited in claim 8.

24. A volatile or non-volatile computer-readable storage medium carrying one or more sequences of instructions which, when executed by one or more processors, cause the one or more processors to perform the steps recited in claim 9.

25. A volatile or non-volatile computer-readable storage medium carrying one or more sequences of instructions which, when executed by one or more processors, cause the one or more processors to perform the steps recited in claim 10.

26. A volatile or non-volatile computer-readable storage medium carrying one or more sequences of instructions which, when executed by one or more processors, cause the one or more processors to perform the steps recited in claim 11.

27. A volatile or non-volatile computer-readable storage medium carrying one or more sequences of instructions which, when executed by one or more processors, cause the one or more processors to perform the steps recited in claim 12.

28. A volatile or non-volatile computer-readable storage medium carrying one or more sequences of instructions which, when executed by one or more processors, cause the one or more processors to perform the steps recited in claim 13.

29. A volatile or non-volatile computer-readable storage medium carrying one or more sequences of instructions which, when executed by one or more processors, cause the one or more processors to perform the steps recited in claim 14.

30. A volatile or non-volatile computer-readable storage medium carrying one or more sequences of instructions which, when executed by one or more processors, cause the one or more processors to perform the steps recited in claim 15.
